(19) United States
(12) Patent Application Publication
(10) Pub. No.: US 2026/0351558 A1
(43) Pub. Date: Nov. 5, 2026

(54) METALLIC LITHIUM WEB COATING VIA DIRECT FLUORINATED PET FILM CARRIERS AND TRANSFER LAMINATION METHODS

(71) Applicant: Applied Materials, Inc., Santa Clara, CA (US)

(72) Inventors: David Masayuki Ishikawa, Santa Clara, CA (US); Thomas Humphreys, Santa Clara, CA (US); Kenneth Moyers, Santa Clara, CA (US); Kashish Sharma, Santa Clara, CA (US)

(21) Appl. No.: 19/124,702

(22) PCT Filed: Oct. 26, 2023
(86) PCT No.: PCT/US2023/036038

§ 371 Date: Apr. 25, 2025

Related U.S. Application Data
(60) Provisional application No. 63/381,356, filed on Oct. 28, 2022.

(51) Int. Cl. H01M 4/1395; H01M 4/02; H01M 4/04; H01M 4/36

(52) U.S. Cl. CPC H01M 4/1395; H01M 4/049; H01M 4/366; H01M 2004/027

(57) ABSTRACT

A method and system for producing a release layer on a carrier film is provided. The release layer is produced through direct fluorination processing of the carrier film prior to deposition of an alkali metal such as lithium. The carrier film is then laminated with a desired anode. The fluorine-based release layer allows efficient release of the deposited lithium from the carrier film after lamination while preventing contamination of the metallic lithium from outgassing by the carrier film. The release layer allows the carrier film to be configured for reuse minimizing hazardous waste and improving cost-efficiency. The carrier film may also be provided with a second fluorinated layer on the back end of the carrier film. This allows the carrier film to also be preserved.

### CROSS-REFERENCE TO RELATED APPLICATIONS

This application is a U.S. National Stage Application of International Application No. PCT/US2023/036038 filed Oct. 26, 2023, which claims the benefit of U.S. Provisional Application No. 63/381,356 filed Oct. 28, 2022, both of which are incorporated herein by reference in their entirety.

### BACKGROUND

### Field

Embodiments of the present disclosure generally relate to a process and apparatus for coating electrodes.

### Description of the Related Art

Lithium (Li) ion batteries have played a vital role in the development of current generation mobile devices, microelectronics, and electric vehicles. A typical Li-ion battery is made of a positive electrode (cathode), a negative electrode (anode), an electrolyte to conduct ions, a porous separator membrane (electrical insulator) between the two electrodes to keep the electrodes physically apart, and packaging.

Typically, lithium batteries can include a graphitic material as the anode. Use of graphite can have a lower capacity in comparison with the use of silicon-blended graphite. Currently, the industry is moving away from graphitic-based anodes to silicon-blended graphite to increase energy cell density. Silicon blended graphite anodes can show first cycle irreversible capacity loss (IRC). Li-ion battery specific energy and energy density appreciably declines due to active lithium loss during the first cycle charge when approximately five to twenty percent of the lithium from the cathode is consumed by solid electrolyte interphase formation (“SEI”) at the anode.

Further, the vapor deposition rate on these materials has been limited. In silicon blended anodes, the binder in the anode is sensitive to temperature. If the lithium is deposited at too high of a rate, it can degrade the polymer binder in the anode. In copper current collectors, if the lithium deposition rate is too high, the copper foil becomes wrinkled or otherwise damaged. To be more economically viable, another method must be employed to deposit lithium onto the anode materials while maintaining a high throughput.

A carrier film may be used as a substrate in a pre-lithiation process for depositing the lithium before transferring the deposited lithium from the carrier to the anode. As vapor depositing lithium onto the carrier film does not require the same equipment complexity that depositing lithium onto an anode does, such as not requiring a vacuum system, pre-lithiation may be more economical while also allowing a higher purity of lithium than traditional methods like using stabilized lithium metal powder (SLMP) or rolled lithium foil.

However, pre-lithiation by coating on a plastic carrier film is often low yield or produces contaminated material. Conventional lithium sources for alloy type anode pre-lithiation or solid metal anode preparation rely on protection layer deposition on metallic lithium (e.g., carbonate coatings on free-standing foils or dispersed particles). High surface energy siloxanes and other release agents contain oxygen, nitrogen, and hydrogen that-with intrinsic carrier film moisture-contaminate metallic lithium.

Additionally, the issue of how the lithium is removed from the plastic carrier film has not been adequately addressed. If lithium is deposited on a plastic carrier film without a release layer, lithium may be removed once enough time passes to allow the lithium to react with the silicon in the anode. Doing so, however, does not allow for high volume or high speed manufacturing. For lithium that is rolled onto a carrier film, there often is high contamination from the hydrocarbons used to roll the lithium or from oxidation with ambient air while waiting for the lithium to percolate.

Commercially available lithium may be provided on lamination plastic carriers for pre-lithiating silicon anodes. Yet, releasing or peeling the lithium from the plastic carrier once the lithium is deposited onto the anode is currently uncontrolled. These commercially available solutions also require thick plastic layers for the carrier film which are prone to interface and surface contamination due to carrier outgassing and air reaction. Commercially available evaporated lithium on current carriers often have lithium thickness variations and wrinkles in the current carrier.

The above described methods also produce hazardous plastic waste as the plastic carrier, after the lithium is placed onto the anode, contain trace amounts of lithium increasing waste disposal expense.

Therefore, there is a need for improved methods of producing metallic lithium on a carrier film and improved methods of placing the metallic lithium onto an anode.

### SUMMARY

Embodiments of the present disclosure generally relate to a process and apparatus for coating electrodes.

In an embodiment, a method for manufacturing energy storage devices is provided. The method includes inspecting a carrier film, exposing the carrier film to a fluorine-containing gas to produce a first fluorinated layer on a top surface of the carrier film, depositing an alkali metal layer on a top surface of the first fluorinated layer to produce a coated film. The method further includes laminating the coated film with an anode to produce a laminated film. The method also includes releasing the carrier film from the anode, the alkali metal layer, and the first fluorinated layer to produce a released carrier film including the carrier film. The method may further include inspecting, neutralizing, and cleaning the released carrier film, and exposing the released carrier film to the fluorine-containing gas to produce a second fluorinated layer on the top surface of the released carrier film.

In another embodiment, a directly-fluorinated carrier film including a carrier film is provided. The directly-fluorinated carrier film includes a first fluorinated layer on a top surface of the carrier film, and an alkali metal layer on a top surface of the first fluorinated layer. The directly-fluorinated carrier film further includes an alkali metal protection layer on a top surface of the alkali metal layer. The alkali metal protection layer includes lithium carbonate, lithium fluoride, or bismuth. The carrier film has a thickness of between 10 μm and 150 μm. The directly-fluorinated carrier film further includes a second fluorinated layer on a bottom surface of the carrier film. The carrier film is also configured to be laminated with an anode.

In yet another embodiment, a method for lithiating an anode is provided. The method includes cleaning an anode, depositing an alkali metal layer on an outer surface of the anode, and exposing the anode and alkali metal layer to a fluorine-containing gas to produce a fluorinated layer on an outer surface of the alkali metal layer, where the alkali metal layer includes lithium.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments of the disclosure and are therefore not to be considered limiting of its scope, as the disclosure may admit to other equally effective embodiments.

FIG. 1 is a schematic view of a direct fluorination process on a carrier film according to one embodiment.

FIG. 2 is a schematic view of a fluorination chamber according to one embodiment.

FIG. 3A is a schematic cross-sectional view of a directly-fluorinated carrier film according to one embodiment.

FIG. 3B is a schematic cross-sectional view of a directly-fluorinated carrier film according to one embodiment.

FIG. 3C is a schematic cross-sectional view of a directly-fluorinated carrier film according to one embodiment.

FIG. 4 is a schematic view of a directly fluorinated carrier film manufacturing system according to one embodiment.

FIG. 5 is a schematic cross-sectional view of a directly-fluorinated carrier film according to one embodiment.

FIG. 6A is a schematic view of an embodiment of a direct fluorination process on an anode.

FIG. 6B is a schematic view of a fluorination chamber according to one embodiment.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Energy storage devices, for example, Li-ion batteries, typically include a positive electrode (e.g., cathode) and a negative electrode (e.g., anode) separated by a plurality of layers. Substrate independent direct transfer (SIDT) is a method to pre-lithiate anodes in energy storage devices in order to improve the life cycles of the batteries. These anodes can include, but are not limited to, graphite, silicon, silicon graphite, silicon oxide graphite, silicon, metalized plastic, and copper. In SIDT processes, lithium is first deposited on a support layer composed of one or more hydrogen-carbon based polymers such as polyethylene terephthalate (PET), polyethylene naphthalate (PEN), polyimide (PI), or combinations thereof. The materials on the support layer are directly transferred to the anode for pre-lithiation. A release layer enables transferring lithium and other materials off of the support layer and onto the anode.

Conventional release layers remain on the support layer after transferring the lithium and other layers. This decreases the ability for the support layers to be reused in subsequent SIDT processes. This also causes the lithium transferred onto the anode to be exposed, which can affect device stability, especially at higher temperatures. The device and methods described herein enable transferring the release layer along with the lithium layer to the anode in which the release layer acts as a protective layer over the lithium upon transfer.

Direct fluorination of the support layer or carrier film provides tunable release properties with an electrochemically compatible and reclaimable or regenerative interface, versus lithium nitride or oxide contaminated siloxane release interfaces. The disclosed subject matter avoids the need to protect as-deposited metallic lithium by addressing surface contamination with an engineered release layer on the carrier film. Further, direct fluorination minimizes carrier film waste by allowing reuse of the carrier film after release.

The disclosed subject matter provides process knobs including fluorinated layer thickness optimization and regeneration to maximize anode specific performance, yield and economy. Metallic lithium deposited by physical vapor deposition (PVD) can thus be ex situ laminated on substrates without surface contamination from the carrier film itself; further the carrier film can be reclaimed and regenerated to minimize consumable cost. The disclosed subject matter is also useful to directly fluorinate other anode active material (AAM) and cathode active material (CAM).

Direct contact pre-lithiation then is possible by thermal evaporation of metallic lithium on a direct fluorinated carrier film. Double-sided direct fluorination provides a barrier against carrier film outgassing which would contaminate the evaporated metallic lithium. Further, the metallic lithium at the fluorinated interface has reproducible release properties without interfacial contamination. The absence of interfacial contamination at the release interface facilitates carrier film reuse to minimize consumable waste and maximize transfer lamination economy.

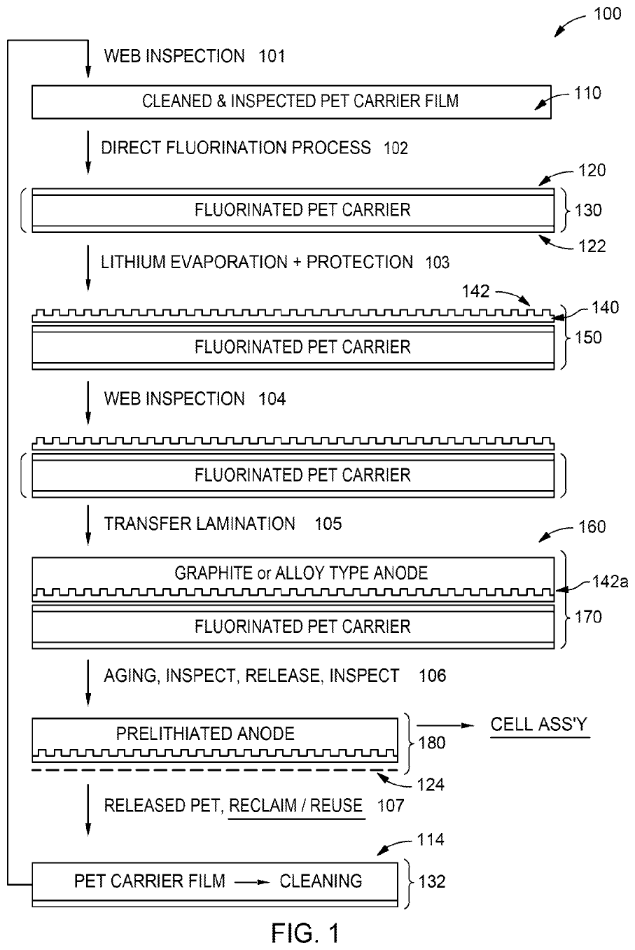

FIG. 1 illustrates a schematic cross-sectional view of one implementation of a directly fluorinated film carrier manufacturing process 100. The manufacturing process 100 includes a first web inspection 101, a direct fluorination process 102, an alkali-metal evaporation and protection process 103, a second web inspection process 104, a transfer lamination process 105, an aging and release process 106, and reclaiming and reuse process 107.

The first web inspection 101 includes an inspection of a cleaned carrier film 110. The carrier film 110 may include any hydrogen-carbon based polymer, such as polyethylene terephthalate (PET), polyethylene naphthalate (PEN), polyimide (PI), or combinations thereof. The carrier film has a thickness of between 12 μm and 150 μm. The inspection determines whether the carrier film 110 is suitable for further processing, such as identifying any wrinkles on the carrier film 110, any thinning of the carrier film 110, or any undesired particles that remain on the carrier film 110.

Once the first web inspection 101 is complete, the carrier film 110 then undergoes a direct fluorination process 102. The direct fluourination process 102, further described below, results in fluorinated carrier film 130 including a first fluorinated layer 120 created on a top surface of the carrier film 110. Preferably, the fluorinated carrier film 130 may also include a second fluorinated layer 122 on a bottom surface of the carrier film 110. The second fluorinated layer 122 prevents front contamination on rewinding obviating the need for an interleaf and protection layer.

Once the fluorinated carrier film 130 is created, the fluorinated carrier film 130 may then undergo an evaporation deposition process 103 to produce a coated film 150. A layer of an alkali metal such as lithium is evaporated onto the first fluorinated layer 120 to create a metallic layer 140 on top of the first fluorinated layer 120. An air-stable metallic protection layer 142 is deposited on the exposed surface of the metallic layer 140 to protect the metallic layer 140. The metallic protection layer 142 may comprise air-stable materials including lithium carbonate (Li₂CO₃), lithium fluoride (LiF), or bismuth (Bi) or a combination thereof and has a thickness of at least 1 μm or more, preferably 2 μm or more.

The coated film 150 may then undergo a second web inspection process 104 where the coated film 150 is inspected for uniform alkali metal thickness of the metallic layer 140 and determine any level of contamination in the coated film 150. This second web inspection process 104 may be completed visually or using instruments, such as an instrument using Eddy currents to determine alkali metal thickness and uniformity.

The coated film 150 is configured to undergo a transfer lamination process 105 to produce a laminated layer 170. The transfer lamination process 105 may laminate a top surface 142a of the metallic protection layer 142 of the coated film 150 with a graphite or alloy-type anode layer 160. The laminated layer 170 comprises the coated film 150 and the anode layer 160. The metallic protection layer 142 acts as a buffer layer between the metallic layer 140 and the anode layer 160 and prevents contamination of the metallic layer 140.

The laminated layer 170 may then undergo an aging and release process 106. The laminated layer 170 may then be aged an appropriate length of time. Once the laminated layer 170 is aged, a release process may be used to separate a cell layer 180 comprising the anode layer 160, the metallic protection layer 142, the metallic layer 140, and the first fluorinated layer 120 from a released film 132 comprising the carrier film 110 and the second fluorinated layer 122. Upon release, the first fluorinated layer 120 transforms into a low-impedance release interface 124. The release interface 124 has a low thermal impedance. The cell layer 180 is further processed in a cell assembly (not shown).

The aging and release process 106 also produces the released film 132. The released film comprises the carrier film 110, the second fluorinated layer 122, and an exposed surface 114 located on the top surface of the carrier film 110. The released film 132 may then be reclaimed, cleaned, and reused in the manufacturing process 100. The released film 132 may then undergo a subsequent iteration of the direct fluorination process 102. The subsequent iteration of the direct fluorination process 102 may produce a third fluorinated layer on the top surface of the carrier film 110 opposite the second fluorinated layer 122. Despite the subsequent iteration of the direct fluorination process 102, the thickness of the second fluorination layer 122 remains substantially the same. Alternatively, the released film 132 may be flipped such that the second fluorinated layer 122 becomes a top surface of the carrier film 110 and the exposed surface 114 becomes a bottom surface of the carrier film 110 before the subsequent direct fluorination process 102.

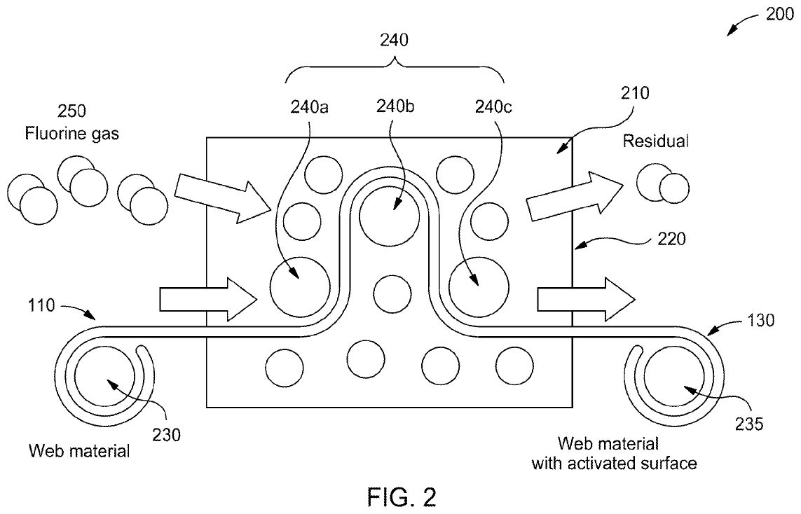

FIG. 2 illustrates an exemplary fluorination chamber used in an embodiment of the disclosed subject matter. A fluorination system 200 comprises a fluorination chamber 210 comprising a chamber body 220 and at least one fluorination drum 240. In the exemplary embodiment, the at least one fluorination drum 240 comprises a first fluorination drum 240a, a second fluorination drum 240b, and a third fluorination drum 240c, but the at least one fluorination drum 240 may comprise one fluorination drum or any desired amount of fluorination drums. A feed drum 230 external to the fluorination chamber 210 provides a roll of the carrier film 110 into the fluorination chamber 210 through the first fluorination drum 240a, the second fluorination drum 240b, and the third fluorination drum 240c then to a receiving drum 235 external to the fluorination chamber. While the carrier film 110 is moving through the fluorination chamber 210, the carrier film is exposed to a fluorine-containing gas 250 in a continuous treatment process. Exposing the carrier film 110 to the fluorine-containing gas 250 produces the first fluorinated layer 120 and the second fluorinated layer 122 on the carrier film. The fluorination in the fluorination chamber 210 is a diffusion-controlled process where the rate of formation of a fluorinated layer is limited by the rate of penetration of fluorine into the surface of the carrier film 110. Thus, the treatment results are determined by the throughput rate of the carrier film 110 and the fluorine concentration of the fluorine-containing gas 250. The fluorination system 200 may also be designed to treat a wide range of web materials of varying thicknesses and widths from the feed drum 230 to the receiving drum 235.

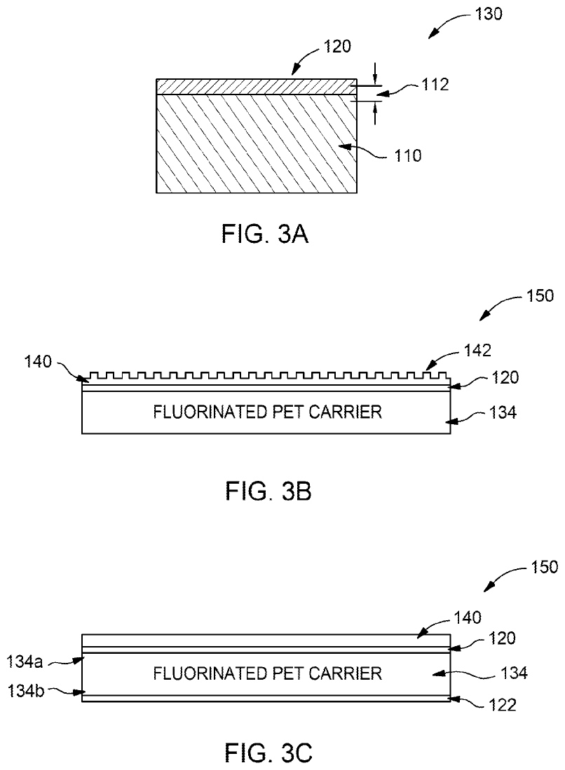

FIG. 3A is a schematic cross-section of the fluorinated carrier film 130. After fluorination in the fluorination chamber 210, the fluorinated carrier film 130 comprises the first fluorinated layer 120 and the carrier film 110. The fluorinated carrier film 130 also comprises a reaction layer 112 in between the unmodified carrier film 110 and the first fluorinated layer 120. The reaction layer 112 comprises a fluorine and polymer reaction zone where fluorine is still reacting with the polymer material of the carrier film 110. The first fluorinated layer 120 serves as an unmodified layer outgassing barrier and a surface for alkali metal condensation and layer separation. The first fluorination layer 120 is an alkali metal compatible surface that prevents alkali-metal contamination of the carrier film 110 by acting as a barrier between the polymer material of the carrier film 110 and the deposited alkali metal layer.

FIG. 3B illustrates a schematic cross-section of the coated film 150 according to an exemplary embodiment. The coated film comprises an unmodified polymer layer 134 of the carrier film 110 wherein the unmodified polymer layer 134 comprises a hydrogen-carbon based polymer. The first fluorinated layer 120 is stacked on the unmodified polymer layer 134 and the metallic layer 140 is stacked on the first fluorinated layer 120. The metallic layer 140 may be deposited to a thickness of at least 1 μm, preferably at least 2 μm. The metallic protection layer 142 is then deposited onto the metallic layer 140 at a thickness of at least 5 nm, preferably at least 10 nm.

FIG. 3C illustrates a schematic cross-section of the coated film 150 according to an exemplary embodiment. The coated film comprises an unmodified polymer layer 134 of the carrier film 110 wherein the unmodified polymer layer 134 comprises a hydrogen-carbon based polymer and further comprises a top surface 134a and a bottom surface 134b that are coincident with a top surface of the carrier film 110 and bottom surface of the carrier film 110. The first fluorinated layer 120 is stacked on the top surface 134a of the unmodified polymer layer 134 and the second fluorinated layer 122 is stacked on the bottom surface 134b of the unmodified polymer layer 134. The metallic layer 140 may be deposited onto a top surface of the first fluorinated layer 120 to a thickness of at least 1 μm, preferably at least 2 μm. Providing the second fluorination layer 122 on the bottom surface 134b of the carrier film 110 protects the metallic layer 140 (e.g., metallic lithium) from backside outgassing-induced surface contamination and obviates the need for a metallic protection layer 142 on the metallic layer 140.

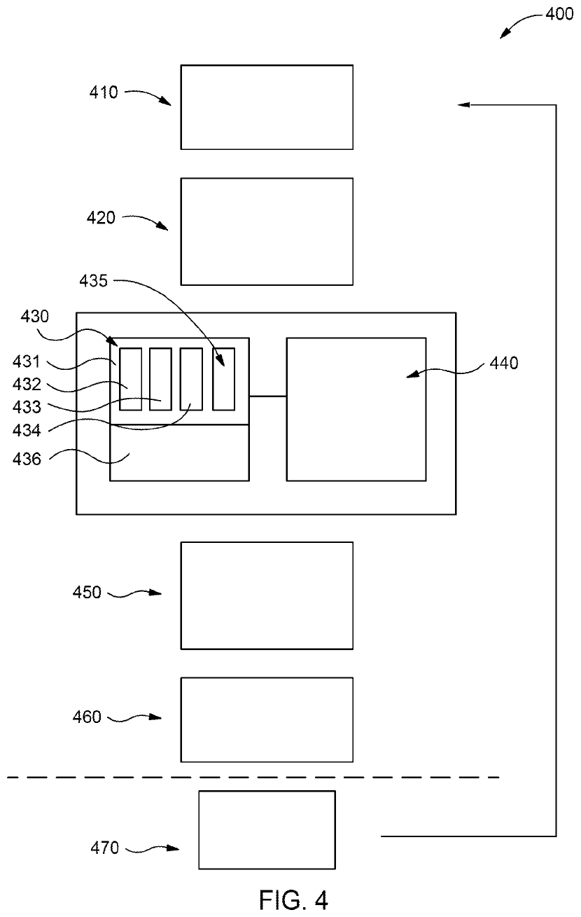

FIG. 4 illustrates a schematic of an exemplary direct fluorination system embodiment. A direct fluorination system 400 may comprise a cleaner 410 for the controlled in-situ dissolution of an alkali metal such as lithium to neutralize the surface of a film carrier (e.g., carrier film 110). The direct fluorination system 400 may also comprise a strip washer 420 to wash the film carrier (e.g., carrier film 110). The direct fluorination system 400 may also comprise a fluorination system 430 configured to deliver a fluorine-containing gas (e.g., fluorine-containing gas 250) further comprising a gas cabinet 431. The gas cabinet 431 may include a fluorine gas tank 432, a purge gas tank 433, a scrubber 434 and a vacuum 435 all in fluid connection with an exhaust system 436. The gas cabinet 431 of the fluorination system 430 may be in fluid connection with a fume hood 440. The fluorination system 430 may be configured to expose a carrier film (e.g., carrier film 110) to a fluorine-containing gas (e.g., fluorine containing gas 250) to produce one or more fluorinated layers (e.g., first fluorinated layer 120 and second fluorinated layer 122) on the carrier film. The direct fluorination system 400 may also comprise a vacuum furnace 450.

The direct fluorination system 400 may also comprise an alkali metal evaporator system 460 for depositing alkali metals such as lithium. The evaporator system 460 may comprise a system to perform physical vapor deposition (PVD) coating of an alkali metal onto the film carrier (e.g., fluorinated film 130). The evaporator system 460 may be configured to deposit an alkali metal layer (e.g., metallic layer 140) onto a carrier film (e.g., fluorinated film 130). The evaporator system 460 may be configured to also deposit a metal protection layer (e.g., metal protection layer 142) comprising air-stable materials such as Li₂CO₃, LiF, Bi, or a combination thereof onto the alkali metal layer.

The direct fluorination system 400 produces fluorinated carrier films (e.g., fluorinated film 130) that are coated by an alkali metal such as lithium wherein the coated fluorinated carrier films (e.g., coated film 150) is configured to be laminated using conventional laminators 470. The coated fluorinated carrier films, once laminated (e.g., laminated layer 170), are configured to release the alkali metal-anode layers (e.g., metallic layer 140, metallic protection layer 142, and anode layer 160) via a release layer (e.g., release interface 124) from a released carrier film (e.g., released film 132). The direct fluorination system 400 also configures the released carrier film (e.g., released film 132) to be reused in a direct fluorination process, a lamination process, an alkali metal coating process, or a combination thereof.

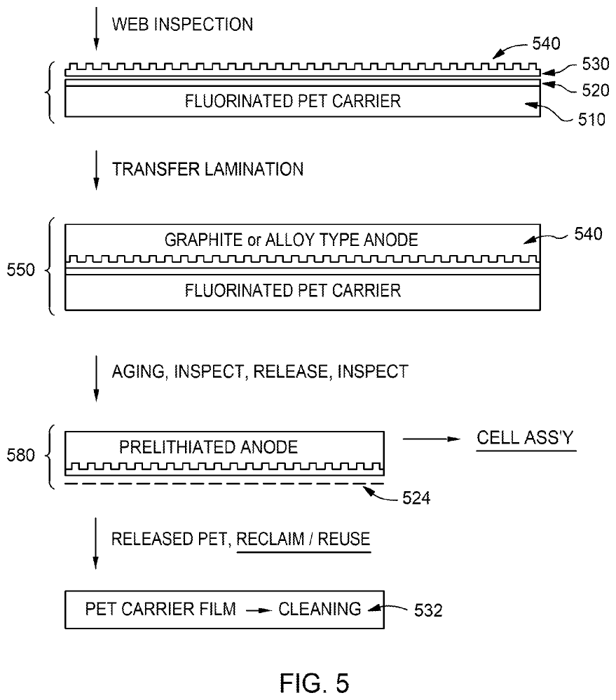

FIG. 5 illustrates a schematic of an exemplary lamination process, e.g., the transfer lamination process 105. After a carrier film 510 is fluorinated and has a metallic layer 530 deposited onto an outer surface of at least one fluorinated layer 520, a graphite or alloy-type anode layer 540 may be laminated onto the outer surface of each metallic layer 530 to produce a laminated film 550. The lamination of the carrier film 510, metallic layer 530, and at least one fluorinated layer 520 involves calendaring the anode layer 540. Once calendaring of the laminated film 550 is complete, in situ metrology is used to verify that no over-calendaring has occurred and there are no lamination defects on the laminated film 550. The metallic layer, the anode layer, and a release interface 524 are released from the carrier film 510 producing a released film 532 that may be reclaimed and reused.

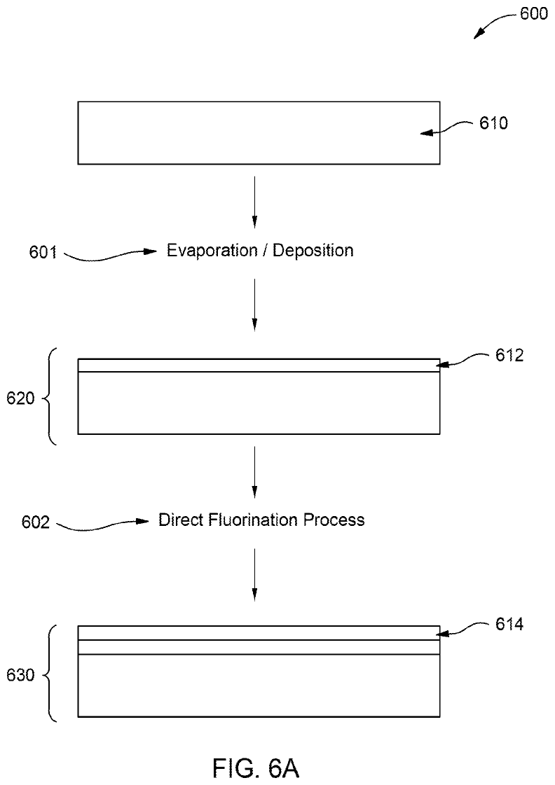

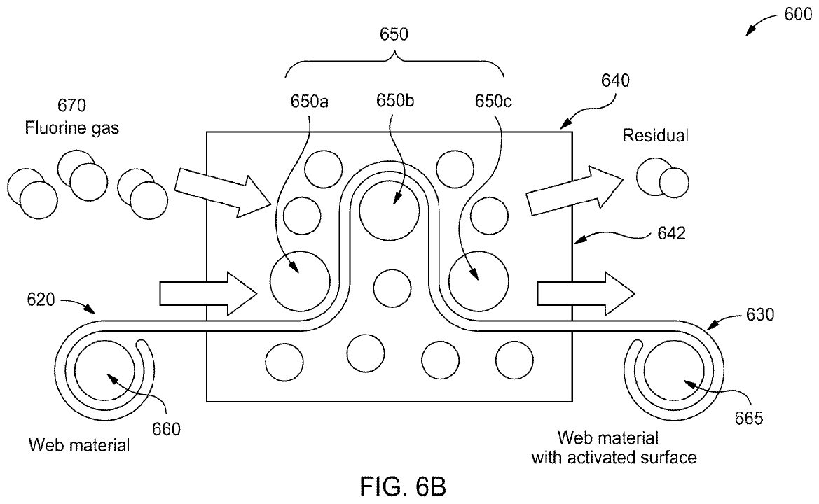

FIG. 6A illustrates a schematic cross-sectional view of an exemplary embodiment of a fluorinated anode. Anode 610 may comprise a graphite or alloy-type anode. The anode 610 may undergo an evaporation process 601 wherein an alkali metal layer 612 is deposited onto an outer surface of the anode 610 to produce an alkali metal coated anode 620. The alkali metal layer 612 may comprise any alkali metal such as lithium. The evaporation process 601 may be an evaporative deposition process such as physical vapor deposition (PVD). The coated anode 620 may then undergo a direct fluorination process 602 wherein the alkali metal layer 612 is exposed to a fluorine-containing gas 250 and a fluorinated layer 614 is formed on an outer surface of the alkali metal layer 612. The fluorinated layer 614 may comprise any alkali metal and fluorine compound such as lithium fluoride (LiF). The fluorination process 602 produces a fluorinated alkali anode stack 630 similar to cell layer 180 in FIG. 1 which may then be processed in a cell assembly (not shown).

FIG. 6B illustrates a schematic of an exemplary system to fluorinate alkali-metal anodes. A fluorination system 600 comprises a fluorination chamber 640 comprising a chamber body 642 and at least one fluorination drum 650. In the exemplary embodiment, the at least one fluorination drum 650 comprises a first fluorination drum 650a, a second fluorination drum 650b, and a third fluorination drum 650c, but the at least one fluorination drum 650 may comprise one fluorination drum or any desired amount of fluorination drums. A feed drum 660 external to the fluorination chamber 640 provides a roll of the coated anode 620 into the fluorination chamber 640 through the first fluorination drum 650a, the second fluorination drum 650b, and the third fluorination drum 650c then to a receiving drum 665 external to the fluorination chamber.

While the coated anode 620 is moving through the fluorination chamber 640, the coated anode 620 is exposed to a fluorine-containing gas 670 in a continuous treatment process. The fluorine-containing gas 670 reacts with the alkali metal layer 612 to form the fluorinated layer 614 on the alkali metal layer 612. The fluorination in the fluorination chamber 640 is a diffusion-controlled process where the rate of formation of a fluorinated layer is limited by the throughput rate of the coated anode 620 and the fluorine concentration of the fluorine-containing gas 670. For example, the thickness of the fluorinated layer 614 may be about 380 nm after 12 hours of reaction.

The resulting fluorinated layer 614 may comprise an alkali metal and fluorine compound such as LiF and has an extremely low percentage of oxygen and carbon contaminants. Further, an energy storage cell manufactured with a fluorinated layer (e.g., fluorinated layer 614) such as an LiF-coated lithium cell, exhibits higher discharge capacities than bare lithium and while maintaining durability.

While the foregoing is directed to embodiments, other and further embodiments may be devised without departing from the basic scope, and the scope is determined by the claims that follow.

What is claimed is:

1. A method for manufacturing energy storage devices, comprising:
inspecting a carrier film;
exposing the carrier film to a fluorine-containing gas to produce a first fluorinated layer on a top surface of the carrier film;
depositing an alkali metal layer on a top surface of the first fluorinated layer to produce a coated film.

2. The method of claim 1, further comprising laminating the coated film with an anode to produce a laminated film.

3. The method of claim 2, further comprising releasing the carrier film from the anode, the alkali metal layer, and the first fluorinated layer to produce a released carrier film comprising the carrier film.

4. The method of claim 3, further comprising:
inspecting, neutralizing, and cleaning the released carrier film; and
exposing the released carrier film to the fluorine-containing gas to produce a second fluorinated layer on the top surface of the released carrier film.

5. The method of claim 1, wherein the carrier film comprises a hydrogen-carbon based polymer.

6. The method of claim 1, further comprising depositing an alkali metal protection layer on a top surface of the alkali metal layer.

7. The method of claim 1, wherein the carrier film has a thickness of between 10 μm and 150 μm.

8. The method of claim 1, further comprising exposing the carrier film to the fluorine-containing gas to produce a second fluorinated layer on a bottom surface of the carrier film.

9. The method of claim 8, further comprising laminating the coated film with an anode to produce a laminated film.

10. The method of claim 9, further comprising releasing the carrier film and the second fluorinated layer from the anode, the alkali metal layer, and the first fluorinated layer to produce a released carrier film comprising the carrier film and the second fluorinated layer.

11. The method of claim 10, further comprising:
inspecting, neutralizing, and cleaning the released carrier film; and
exposing the released carrier film to the fluorine-containing gas to produce a third fluorinated layer.

12. The method of claim 10, further comprising:
inspecting, neutralizing, and cleaning the released carrier film; and
depositing a second alkali metal layer on an outer surface of the second fluorinated layer.

13. A directly-fluorinated carrier film comprising:
a carrier film;
a first fluorinated layer on a top surface of the carrier film; and
an alkali metal layer on a top surface of the first fluorinated layer.

14. The directly-fluorinated carrier film of claim 13, further comprising an alkali metal protection layer on a top surface of the alkali metal layer.

15. The directly-fluorinated carrier film of claim 14, wherein the alkali metal protection layer comprises lithium carbonate, lithium fluoride, or bismuth.

16. The directly-fluorinated carrier film of claim 13, wherein the carrier film has a thickness of between 10 μm and 150 μm.

17. The directly-fluorinated carrier film of claim 13, further comprising a second fluorinated layer on a bottom surface of the carrier film.

18. The directly-fluorinated carrier film of claim 13, wherein the carrier film is configured to be laminated with an anode.

19. A method for lithiating an anode, comprising:
cleaning an anode;
depositing an alkali metal layer on an outer surface of the anode; and
exposing the anode and alkali metal layer to a fluorine-containing gas to produce a fluorinated layer on an outer surface of the alkali metal layer.

20. The method of claim 19, wherein the alkali metal layer comprises lithium.
